(19) United States
(12) Patent Application Publication
(10) Pub. No.: US 2005/0225080 A1
(43) Pub. Date: Oct. 13, 2005

(54) Document containing security images

(76) Inventor: Thomas M. Wicker, Hemlock, NY (US)

Correspondence Address: McDERMOTT WILL & EMERY LLP, 600 13th Street, N.W., Washington, DC, 20005-3096, US

(21) Appl. No.: 10/895,822

(22) Filed: Jul. 22, 2004

Related U.S. Application Data
(63) Continuation of application No. PCT/US23/32159, filed on Oct. 9, 2003.
(60) Provisional application No. 60/417,753, filed on Oct. 10, 2002.
(60) Provisional application No. 60/417,754, filed on Oct. 10, 2002.
(60) Provisional application No. 60/417,755, filed on Oct. 10, 2002.
(60) Provisional application No. 60/417,756, filed on Oct. 10, 2002.
(60) Provisional application No. 60/417,757, filed on Oct. 10, 2002.
(60) Provisional application No. 60/417,752, filed on Oct. 10, 2002.
(60) Provisional application No. 60/417,751, filed on Oct. 10, 2002.
(60) Provisional application No. 60/417,750, filed on Oct. 10, 2002.
(60) Provisional application No. 60/417,758, filed on Oct. 10, 2002.

(51) Int. Cl. B42D 15/00

(52) U.S. Cl. 283/117

(57) ABSTRACT

A document containing security images which enable original documents to be distinguished from copies of the originals. The document may include a background of a first color and an image formed of a second and third color which appear to be the first color when viewed together, providing a hidden image which does not appear in reproductions of the document. The document may contain a background of a first color printed with lines at a first angle, and an image of the first color but having lines printed at a different angle, providing a hidden image which does not appear in reproductions of the document. The document may contain a background of printed with lines at a first angle and a predetermined line frequency, and an image printed with lines at a second angle and at a line frequency less the one half of the line frequency of the background, providing a substantially hidden image which appears in a reproduction of the document. A document may be authenticated as an original document by detecting the presence of a predetermined hidden security image and/or by determining the layout of the document to be the same as the expected layout of an original document.

This application is a continuation of PCT application PCT/US2003/032159 filed on Oct. 9, 2003 which claims the benefit of each of the following U.S. provisional applications: 60/417,753 titled NEGATIVE AND POSITIVE SECURITY IMAGE PROCESS AND PRODUCT filed Oct. 10, 2002; 60/417,754 titled SECURITY ARTWORK FOR PROTECTION AGAINST DUPLICATION PROCESS AND PRODUCT filed Oct. 10, 2002; 60/417,755 titled ANTI SCANABLE SECURITY IMAGES AND VERIFICATION PROCESS AND PRODUCT filed Oct. 10, 2002; 60/417,756 titled HIGH AND LOW FREQUENCY WARNING WORD BACKGROUND PROCESS AND PRODUCT filed Oct. 10, 2002; 60/417,757 titled SECURITY SCREEN FOR DUPLICATION PROTECTION PROCESS AND PRODUCT filed Oct. 10, 2002; 60/417,752 titled SECURITY PHOTOGRAPH WITH HIDDEN AND READABLE IMAGES PROCESS AND PRODUCT filed Oct. 10, 2002; 60/417,751 titled SOFTWARE VERIFICATION SYSTEM PROCESS AND PRODUCT filed Oct. 10, 2002; 60/417,750 titled HIDDEN SECURITY BAR CODE PROCESS AND PRODUCT filed Oct. 10, 2002; and 60/417,758 titled ANTI SCAN, FAX, COPY, PHOTOGRAPH SECURITY PAPER PROCESS AND PRODUCT filed Oct. 10, 2002. Each of the above applications are herein incorporated by reference in their entirety.

### FIELD OF THE INVENTION

This invention relates generally to document protection methods and products, and more particularly to methods and products for printing and obtaining original documents that can be readily differentiated from copies made of those documents. The document protection method and product also allow detection of an original document by a document reader.

### BACKGROUND OF THE INVENTION

Many methods and products have been developed, for example, to deter counterfeiting of valuable documents or financial instruments such as currency, so that unauthorized copies attempted to be made from those documents can be readily distinguished from the originals. Most of these methods and product involve preparing an original document by printing or lithography on high quality media such as silk, rice paper, and high contact rag paper. The printing of original documents may be done either in black-and-white (B&W) or in color, and if in color, either in spot color, colored backgrounds and/or multicolor printing. In the case of color, the tendency has been in the direction of using multiple colors for original documents for aesthetic value, for ease of recognition, and originally for protection from copying by conventional means. The common printing processes of valuable originals, whether in B&W or in color, are intaglio and gravure, among others. These and the other processes mentioned in this application are very well known in the art and will not be discussed in great detail.

Most of the useful examples in the prior art to deter counterfeiting and the like are intended to ensure that copies are produced either with a clear moiré pattern or with a “latent image” indicia which is invisible or nearly invisible to the naked eye on the original document. The term “latent image” is used here not in the photographic sense of an unseen image to be developed after processing by chemical reaction, but to indicate indicia that are printed on originals so as to be nearly invisible to the naked eye.

These and other developments in the prior art for purposes of providing document protection are disclosed in the patent literature, as for example, in U.S. Pat. No. 5,018,767 issued May 28, 1991; U.S. Pat. No. 5,193,853 issued Mar. 16, 1993; and U.S. Pat. No. 3,675,948 issued Jul. 11, 1972; and U.S. Pat. No. 4,143,967 issued Mar. 13, 1979, all to Ralph C. Wicker; in U.S. Pat. No. 4,227,720 issued Oct. 14, 1980 and U.S. Pat. No. 4,310,180 issued Jan. 12, 1982 both to William H. Mowry, et al, as well as U.S. Pat. No. 5,149,140 issued Sep. 22, 1992 to Mowry et al; and in U.S. Pat. No. 5,487,567 issued Jan. 30, 1996 to John R. Volpe. All of these patents disclose various means for providing methods and products to enable copies of documents to be distinguished from the originals, as for example, by a “large dot-small dot pattern”, a “close line-spaced pattern”, and images or indicia which are screen printed at minutely varied spaces and/or angles on the originals and are intended to produce a highly visible moiré pattern effect on the unauthorized copies. In this specification, the words “print”, “printed” and “printing” are used to refer to the making of an original document regardless of the techniques used, and the words “copy” and “copying” to refer to making copies from an original.

It is well known, however, that copier and computer scanner-printer technology has become even more sophisticated since the development of the prior art in document protection. The goal of copier technology if not already achieved has been, especially in desktop publishing and the like, to obtain copies as good as an original. “What you see is what you get” in color documents has become very achievable in copier and duplicator equipment including scanning input devices, and even desk-top computers have become sufficiently sophisticated in color reproduction, including color matching of copies to color standards such as the PANTONE.RTM. Color Matching System.

Many if not all of the document protection methods and products were developed before this very significant improvement in copier and computer reproduction technology, and have been found not be as effective in the newer color reproduction technology especially on color copiers with a “photo” setting that intentionally copies a document in an “unsharp” focus so as to give the effect of a continuous tone image, the effect of which is to defeat the precise line variation between the copier scanner and the security pattern on the document original. Developed at the time of limited copier and printer advancements, these prior art techniques for document protection may not work as reliably against the many forms of copier/duplicator and computer scanner/output equipment now or soon to be available.

Thus it has become imperative for purposes of document security and safety that further improvements in the area of document protection be found, especially where there is a need to prevent copying or duplicating of valuable originals without readily distinguishing the copies from the originals.

### SUMMARY OF THE INVENTION

It is an object of the invention to overcome the above problems and provide enhanced security for documents.

A document carrying an image may comprise a background portion printed at a first line frequency and at a first color; a first image portion printed at a second line frequency and a second color; and a second image portion printed at the second line frequency and a third color, wherein a combined image the first image portion and the second image portion appear to substantially the same color as the first color. In the document, the first image portion may include printed lines, dots or spots, and the second image portion includes printed lines dots or spots placed between adjacent printed lines dot or spots of the first image portion. In the document, the first image portion may be printed at a density between 5 percent and 95 percent of the combined image of the first and second image portions. When the document is reproduced by a copying or scanning device, a solid tonal color may be reproduced in the area of the first image portion and the second image portion in substantially the same color at the first color, thereby not reproducing the first image portion and the second image portion.

A document carrying an image may comprises: a background portion having printed lines dots or spots at a first angle and at a first color; an image portion having printed lines dots or spots at substantially the same color as the first color and at a different angle than the first angle, wherein when the document is reproduced by a copying or scanning device, a solid tonal color may be reproduced in the area of the image portion in substantially the same color at the first color, thereby not reproducing the first image portion. In the document, at least one of the background portion and the image portion may be printed at a line frequency greater than about 175 lines per inch.

A document carrying an image may comprise: a background portion having printed lines dots or spots at a first angle and at a first line frequency; an image portion have printed lines dots or spots at a second angle and at a second line frequency, wherein the first line frequency is at least two time greater than the second line frequency. In the document, the first line frequency may be greater than about 175 lines per inch. In the document, an image formed by the image portion may be substantially hidden, and when the document is reproduced by a copying or scanning device, the image formed by the image portion is not substantially hidden in the reproduced document.

An apparatus for authenticating a document as an original document may comprise: a magnification unit capable of magnifying images contained on the document; a scanning unit capable of scanning images magnified by the magnification unit, and creating an electronic format of the images contained on the document; a microprocessor which receives the electronic format and determines if the document contains predetermined security images which are not reproduced when the a reproduction of the document is made by a copying or scanning device, wherein the microprocessor determines the document not to be an original document if predetermined security images are not detected. In the apparatus, the microprocessor may compare a layout of the document to a layout of the original document, and the microprocessor may determine the document to be an original document if the layout of the document corresponds to the layout of an original document. The apparatus may further comprise a display which displays a message indicative of whether the document has been determined to be an original document.

A method of authenticating a document as an original document may comprise the steps of: reviewing the document for the presence of predetermined security images which are not reproduced when a reproduction of the document is made by a copying or scanning device; and determining the document not to be an original if the predetermined security images are not present in the document. The method may further comprise the steps of comparing a layout of the document to a layout of the original document, and determining the document to be an original document if the layout of the document corresponds to the layout of an original document. The method may further comprise the step of displaying a message indicative of whether the document has been determined to be an original document.

A computer readable medium may carry instructions to cause a computer to perform a method of authenticating a document as an original document comprising the steps of: reviewing the document for the presence of predetermined security images which are not reproduced when a reproduction of the document is made by a copying or scanning device; and determining the document not to be an original if the predetermined security images are not present in the document. In the computer readable medium, the method may further comprise the steps of comparing a layout of the document to a layout of the original document, and determining the document to be an original document if the layout of the document corresponds to the layout of an original document. In the computer readable, the method may further comprise the step of displaying a message indicative of whether the document has been determined to be an original document.

### BRIEF DESCRIPTION OF THE DRAWINGS

The accompanying drawings, which are incorporated in and form a part of the specification, together with the description serve to explain the principles of the invention. In the drawings:

FIG. 1 illustrates a document having a latent security image;

FIG. 2 illustrates another embodiment of a document having a latent security image which is hidden to the human eye;

FIG. 3 illustrates another embodiment of a document with a latent image;

FIG. 4 illustrates a document which contains a dedicated security image;

FIG. 5 illustrates a document which contains a latent image in the form of a bar code;

FIG. 6 illustrates a document 50 which contains an image 52 which contains distortion or moiré inducing patterns;

FIGS. 7A and 7B illustrates an exemplary safety medium which prohibits reproduction of the information contained on the medium;

FIGS. 8A and 8B illustrates documents containing a plurality of security images;

FIG. 9 illustrates an exemplary reading device for detecting security images in a document;

FIG. 10 illustrates an exemplary method of authenticating a document to be an original using the exemplary reading device of FIG. 9; and

FIG. 11 illustrates an exemplary bar code reader capable of detecting a bar code as a latent image.

### DETAILED DESCRIPTION OF THE INVENTION

FIG. 1 illustrates a document 1 having a latent security image 2 which is generally hidden to the human eye. In FIG. 1, a background area 3 is preferably printed at a high line frequency. An image 2 is printed with a first color 4 at a predetermined density and printed with a second color 5 also at a predetermined density. The result is that image 2 appears as a third color to the human eye. Preferably, background area 3 is printed in the third color or a color similar to the third color, causing image 2 to be obscure to the eye.

The image 2 may be formed by printing the first color 4, such as by printing lines 6 having a first color at predetermined pitch and thickness. Then the second color 5 may be printed such as by printing lines 7 having a second color between lines 5 at a predetermined pitch and thickness, such as by using a negative image of image 2. Those of skill in the art will appreciate that lines 6 and 7 may be printed in a single print operation as well, such as by using a laser printer or the like. Also, although only two colors are discussed for purposes of illustration, those of skill in the art will appreciate that more than two colors may be used, including six or more colors.

Preferably, the density of lines 6 and 7 are controlled by controlling the pitch (distance between lines), thickness of the lines 6 and 7, or by controlling the density of the medium, such as ink, used to print lines 6 and 7. The density of lines 6 and 7 may range from 5% to 95% depending on the colors selected for lines 6 and 7, the density of the medium, the thickness of the lines, and the desired appearance of image 2. In an exemplary embodiment, a density of 50% for each of lines 6 and 7 may be used, with a red color for line 6 and a green color for line 7. Also in an exemplary embodiment, lines 6 and 7 may be printed at a different angle than used to print background 3.

Image 2 may be detected using a reading device which magnifies the image to reveal the two colors, or selectively screens one of the two colors. When document 1 is copied or scanned by conventional copying or scanning devices, such as a color photocopier, image 2 is substantially not reproduced in the copy. Particularly, the copy of document 1, even if in the same color tone as the original document 1, will contain background area 3 across the entire document, and will not contain image 2. The presence or absence of image 2 may be used to determine if a document is an original or a copy, respectively.

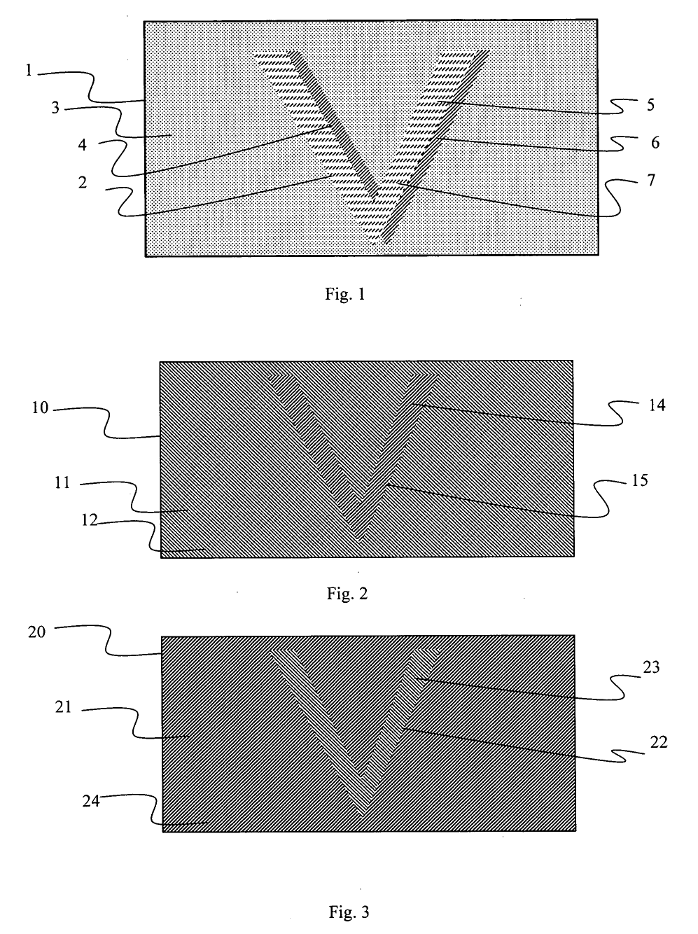

FIG. 2 illustrates a document 10 having a latent security image 14 which appears hidden to the human eye. As illustrated in FIG. 2, document 10 preferably has a background area 11 which contains lines 12 of a high frequency, such as about 175 lines per inch or more. Lines 12 preferably have a color. Image 14 preferably contains lines at about the same frequency but at a different angle from lines 12. Lines 12 and or 15 may be lines, dots or spots.

In an exemplary implementation of the concepts of FIG. 2, lines 12 may be printed in blue at an angle of 30 degrees with a frequency of 280 lines per inch, and lines 14 may be printed at 45 degrees in blue and also with a frequency of 280 lines per inch.

Image 14 may be detected using a reading device which magnifies the image to reveal lines 15 or selectively screens lines 12 to reveal lines 15. When document 10 is copied or scanned by conventional copying or scanning devices, such as a color photocopier, image 14 is substantially not reproduced in the copy. Particularly, the copy of document 10, even if in the same color tone as the original document 10, will contain background area 11 across the entire document, and will not contain image 14. The presence or absence of image 14 may be used to determine if a document is an original or a copy, respectively.

FIG. 3 illustrates a document 20 with a latent image 22. Document 20 contains a background area 21 which is preferably printed at a first frequency, such as 175 lines per inch or greater, and at a predetermined angle. Image 22 is preferably printed at lower frequency than the frequency of background area 21. Preferably, the frequency of lines 24 in area 21 is greater than two times the screen frequency of lines 23 in image 22. More preferably, the line frequency in area 21 is at least three times greater than the line frequency of lines 23 in image 22. The angle of the lines 22 is preferably at a different angle than the angle of lines 24 by at least 5 degrees. The width of lines 24 and 23 may be selected to provide a continuous aesthetically pleasing appearance of the document. Both lines 24 and 23 preferably have the same color.

In an exemplary implementation of a security document using the principles illustrated in FIG. 3, lines 24 in background area 21 may have a frequency of at least 175 lines per inch and preferably of 300 lines per inch, and a line width of 0.0025 inches at a 45 degree angle, and lines 23 in image 14 may have a frequency between 100-133 lines per inch and preferably a frequency of 95 lines per inch at a 30 degree angle.

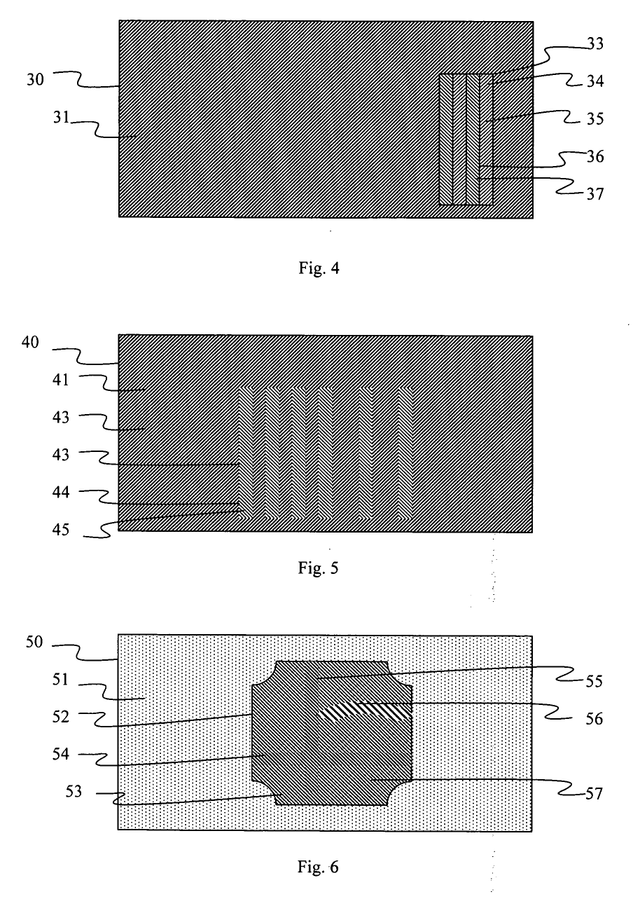

FIG. 4 illustrates a document 30 which contains a dedicated security image 33 having a plurality of high and low frequency portions. As illustrated in FIG. 4, document 30 preferably has a background area 31. Image 33 preferably contains first segments 34 which contains lines 35 which range from a high frequency to a low frequency and second segments 36 which contain lines 37 which range from a low frequency to a high frequency. Although two segments are shown for each of the first and second segments 34 and 36, respectively, any number of segments may be used, including one segment for either segment 34 and 36. The line frequency in each of segments 34 and 36 may change continuously in a linear or non-linear manner or stepwise from one terminal end of each of segments 34 and 36 to the opposite terminal end, respectively. Each of lines 35 and 37 may be printed in black or in any color.

If image 33 is reproduced by conventional copying or scanning devices, the reproduced image will preferably show significant distortions, such as moiré patterns.

FIG. 5 illustrates a document 40 which contains a latent image 43 in the form of a bar code. As illustrated in FIG. 5, document 40 contains a background area 41 which contain lines 42 at a predetermined frequency and predetermined angle. Image 43 preferably contains a plurality of bars 44 which may form a bar code which may contain information readable by a bar code reader. Bars 44 preferably contain lines 45 at a predetermined frequency, which may be the same frequency as lines 42. Lines 45 may preferably be printed at a different angle than lines 42 as discussed in the construction of FIG. 3, or lines 45 and 42 may be printed in similar colors as discussed in the construction of FIG. 2 and FIG. 1. Any suitable technique for providing a latent bar code image that may not be reproduced may be used. In an exemplary construction in accordance with the concepts of FIG. 5, lines 42 and 45 may each be printed at the same frequency, which is a frequency between 150 to 400 lines per inch.

Image 43 may be detected using a reading device which magnifies the image to reveal lines 45 or selectively screens lines 42 to reveal lines 45. A bar code reader may then detect the bar code and read information from the bar code. The information provided by the bar code may include document identifying information or other security information.

When document 40 is copied or scanned by conventional copying or scanning devices, such as a color photocopier, image 43 is substantially not reproduced in the copy. Particularly, the copy of document 40, even if in the same color tone as the original document 40, will contain background area 41 across the entire document, and will not contain image 43. The presence or absence of image 43 may be used to determine if a document is an original or a copy, respectively.

FIG. 6 illustrates a document 50 which contains an image 52 which contains distortion or moiré inducing patterns. As illustrated in FIG. 6, document 50 contains a background portion 51. Image 52 preferably contains a background portion 53 containing lines 57 at a predetermined frequency and multiple portions 54, 55 and 56 which have various line frequencies which may be higher than or lower than the predetermined frequency of lines 57. For example, the line frequencies in portions 54, 55 and 56 may be printed in one or more high frequencies, such as greater than about 175 lines per inch while, background portion 53 may be printed at a low frequency, such as about 100-135 lines per inch. Alternatively, the multi-frequency portions may range from a high frequency in an area to a low frequency in an area next to a high frequency area.

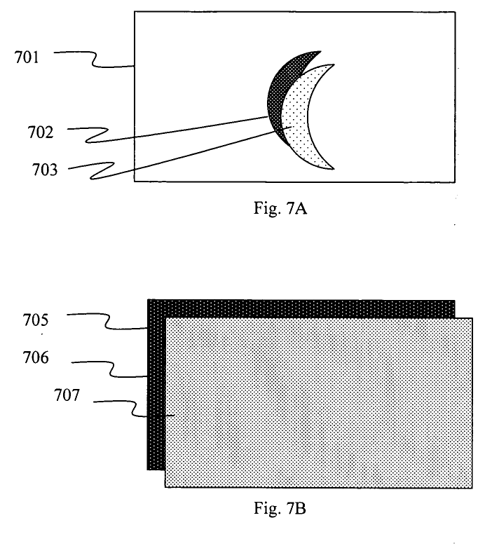

FIGS. 7A and 7B illustrate an image printed on a medium that substantially stops reproduction of information contained on the medium. As illustrated in FIG. 7A, medium 701, such as paper, contains printed images 702 and 703 that preferably interfere with scanners, facsimile machines and laser copiers. A first set of printed images, represented by printed image 702 may be printed in a dark color such as black in negative form. Then a second set of printed images, represented by printed image 703 preferably is a contact positive of the first printed image 702 and may be printed in reflective ink, such as silver ink. Alternatively, as illustrated in FIG. 7B, one of the colors may be printed over all of medium 705 as a solid image 706. Then the second color in a negative form or a positive form image, depending on the form of the first image, respectively, may be printed on top of image 706. In both FIGS. 7A and 7B, reproduction of medium 702 and 705, respectively, will result in a black copy, making the information on medium 702 and 705, respectively, unreadable.

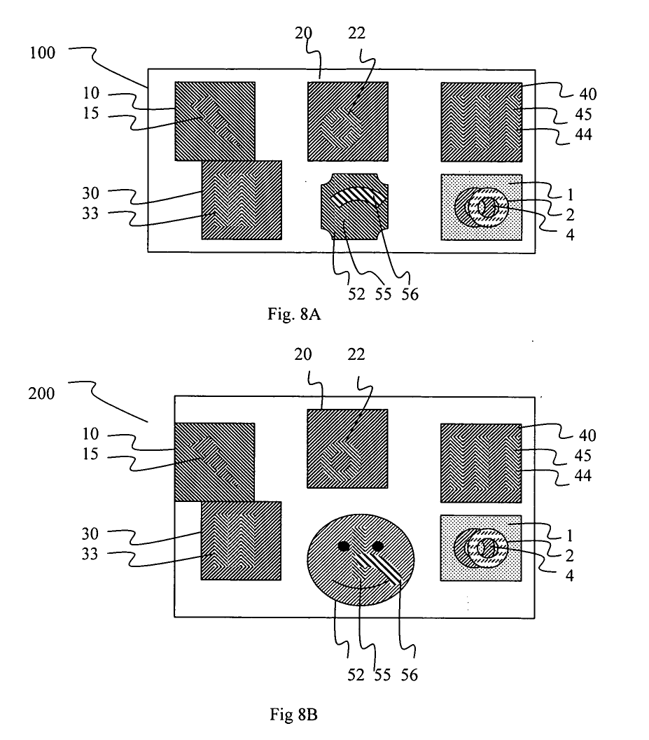

Those of skill in the art will appreciate that any number of the security images described in FIGS. 1-7B may be presented separately or in combination on a single document. FIG. 8A illustrates a document 100 containing a plurality of security images 1, 10, 20, 30, 40, and 52, which are discussed in connection with FIGS. 1-7. FIG. 8B illustrates an identification card 200 containing a plurality of security images 1, 10, 20, 30, 40, and 52, which are discussed in connection with FIGS. 1-7.

Art work may be protected by applying a security image to a part of the work to enable an original work to be distinguished from a copy.

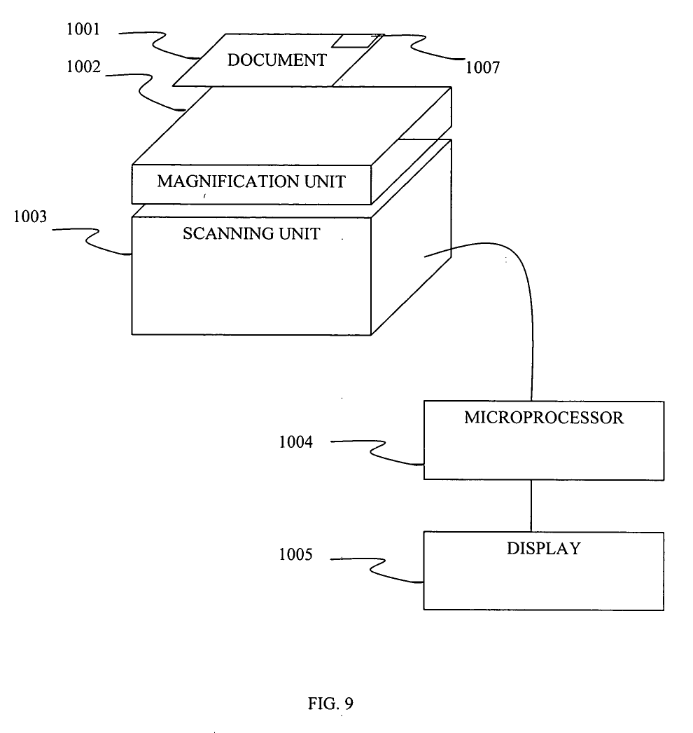

FIG. 9 illustrate an exemplary construction of a reading device which may be used to detect security images in document 100 or card 200. As illustrated in FIG. 9, document 1001 containing security image 1007 may be magnified by magnifying unit 1002 which provides a magnified image to scanning unit 1003. Security image 1007 may formed in accordance with one or more of the techniques illustrated in FIGS. 1-5. Magnifying unit 1002 may be any conventional magnification device as known to those of skill in the art and may be integrally formed with scanning unit 1003 or may be independent of scanning unit 1003. Magnification unit 1002 may enable an optical and/or a digitally enhanced magnification as known to those of skill in the art. A preferred magnification device is capable of providing a magnification of less than 100% of the document image up to 1000% of the document image.

The scanning unit 1003 may be any conventional type of scanning unit, including scanning units capable of providing a digital image of a photograph or of providing an electronic word processor document from a text scan. Scanning unit 1003 may be of the type suitable for use with photographic and text scanners, photocopiers, facsimiles. Scanning unit 1003 preferably generates a scanned representation of a scan of document 1001 and security image 1007, such as a digital representation, and provides this information to a microprocessor 1004. Scanning unit 1003 may contain one or more storage devices (not shown), such as a RAM, floppy disk drive, writeable CD drive, or the like, which may be used to store the scanned representation prior to being sent to the microprocessor.

Microprocessor 1004 processes the scanned representation of document 1001 and particularly of security image 1007. Preferably, microprocessor contains verification software that compares the scanned representation of the document against a representation of the original document previously stored in a memory associated with microprocessor 1004. Alternatively, microprocessor 1004 may retrieve the representation of the original document from a remote location, such as through a website or a secure communication link. Microprocessor 1005 may provide results of the comparison to a display 1005.

Microprocessor 1004 may also instruct an access device to provide access to a user when a valid document or ID card is detected. Those of skill in the art will appreciate that an access device may include access to a room or building through a security door and access to information contained on a data base through a secure access port or a firewall, or may simply include access to complete a financial transaction. Preferably, access is denied when microprocessor 1004 determines that scanned document 1004 is not an original document.

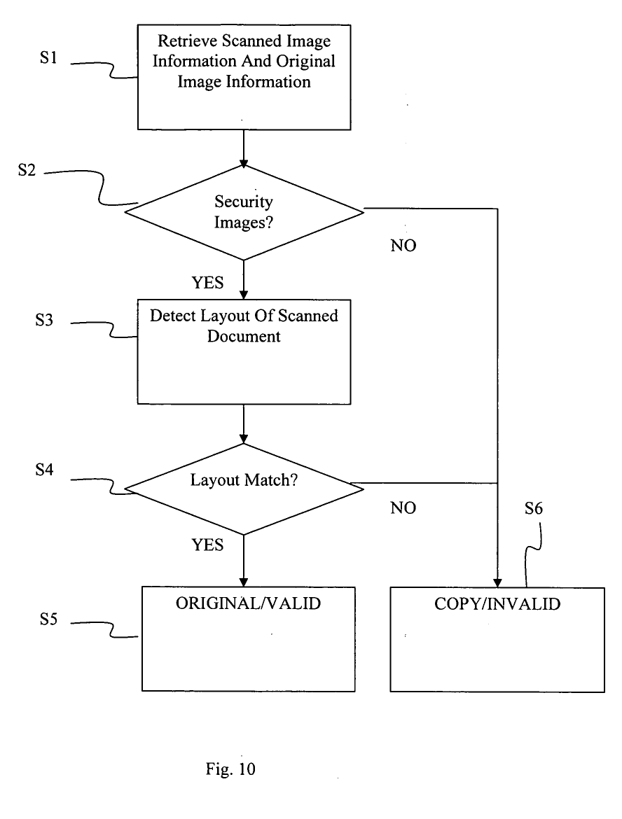

FIG. 10 illustrates an exemplary method of detecting valid original documents using the reading device depicted in FIG. 9. As illustrated in FIG. 10, the scanned representation of document 1001 and a representation of a corresponding original document are retrieved by the microprocessor in step S1. As illustrated in step S2, the microprocessor 1004 reviews the scanned representation of document 1001 to determine if predetermined security images are present in the scanned document, the predetermined security images are preferably images which are latent security images which are not expected to be reproduced in a copy of the document, such as images constructed in accordance with the principles of FIG. 3. If the predetermined security images are not present in document 1001, NO in step S2, then microprocessor 1004 determines that scanned document 1001 is not an original document, and may instruct display 1005 to display “COPY” or “INVALID” or the like instructions.

If the predetermined security images are present in document 1001, microprocessor 1004 may indicate that the document is an original document, or as an increased security measure, microprocessor 1004 may analyze the layout of the scanned document 1001, as illustrated in step S3. The analysis of the layout may include analysis of the location of printed images, both visible images and latent images, analysis of the color, including black and white areas, and/or analysis of the frequency, pitch and/or angles of lines of an image. The layout of scanned document 1001 is compared to the expected layout of an original document, as illustrated in step S4. If the layout of scanned document 1001 does not match the expected layout of an original, NO in step S4, then the microprocessor 1004 determines that scanned document 1001 is not an original document, and may instruct display 1005 to display “COPY” or “INVALID” or the like instructions. If the layout does match the expected layout, YES in step S4, microprocessor 1004 determines that scanned document 1001 is an original or valid document and may instruct display 1005 to display “ORIGINAL” or “VALID”, or the like instructions.

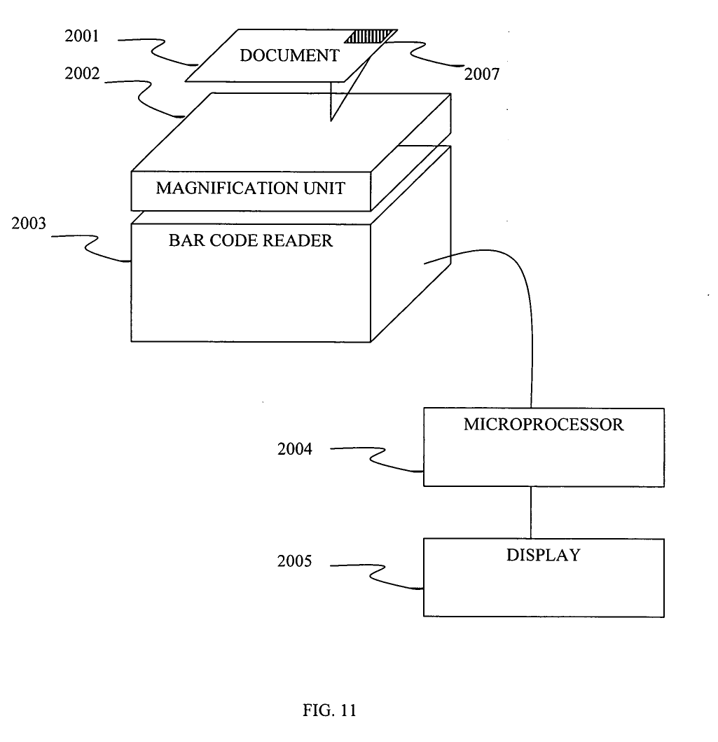

FIG. 11 illustrates an exemplary device for reading a bar code image formed on a document. As illustrated in FIG. 11, document 2001 preferably contains a bar code image 2007 which is hidden to the human eye. Magnifying unit 1002 preferably magnifies bar code image 2007 and provides the magnified image to bar code reader 2003. Bar code reader 2003 is preferably a conventional bar code reader capable of reading a plurality of substantially parallel lines and detecting at least one of the pitch, frequency and thickness of the plurality of the substantially parallel lines. Bar code reader 2003 provides the detected information to a microprocessor 2004, which uses the detected information to determine the content of recorded information in the bar code image 2007. The recorded information may preferably include information of the authenticity and identity of document 2007, such as the name of a person using an identification card as document 2001.

Microprocessor may authenticate document 2001 carrying bar code 2007 in the same manner as illustrated in FIG. 10, in which case bar code 2007, and the corresponding information recorded by bar code 2007, would preferably be one of the detected security images in step S2. For example, as an increased security measure, bar code 2007 may be used with other security images and with the layout of document 2007 to determine if document 2007 is an original or valid document. In this manner, a counterfeit document or a copied document in which bar code 2007 may have been successfully reproduced would result in the denial of access.

The architecture illustrated in each of FIGS. 9 and 11, may be entirely contained in a single device or multiple devices, and the functions associated with the architecture in FIGS. 9 and 11 may be performed by programmable software. Moreover, the operations illustrated in FIG. 10 may be performed by programmable software on an internal or external memory (not shown) associated with microprocessor 1004 or 2004, respectively, such as a ROM or a RAM or any other memory. The software that performs the operations illustrated in FIG. 10 may be embodied in the form of data in a computer readable medium. A computer readable medium within the scope of this disclosure includes any medium, physical or metaphysical, which is capable of carrying information in a form which can be read by an appropriately configured computer or mobile communication device and associated peripheral devices of the computer or station, including, but not limited to: an optical readable/writeable disc, a magnetic disk, a readable/writeable card, a magnetic tape, an electrical transmission signal for wireline or wireless transmission or optical transmission of data using electrical and/or electromagnetic signals. The data associated with the programmable software may be in the form of packetized digital data.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A document carrying an image comprising:
a background portion printed at a first line frequency and at a first color;
a first image portion printed at a second line frequency and a second color; and
a second image portion printed at the second line frequency and a third color,
wherein a combined image the first image portion and the second image portion form substantially the same color as the first color.

2. The document of claim 1, wherein the first image portion includes printed lines, dots or spots, and the second image portion includes printed lines dots or spots placed between adjacent printed lines dot or spots of the first image portion.

3. The document of claim 2, wherein the first image portion is printed at a density between 5 percent and 95 percent of the combined image of the first and second image portions.

4. The document of claim 1, wherein when the document is reproduced by a copying or scanning device, a solid tonal color is reproduced in the area of the first image portion and the second image portion in substantially the same color at the first color, thereby not reproducing the first image portion and the second image portion.

5. A document carrying an image comprising:
a background portion having printed lines dots or spots at a first angle and at a first color;
an image portion having printed lines dots or spots at substantially the same color as the first color and at a different angle than the first angle,
wherein when the document is reproduced by a copying or scanning device, a solid tonal color is reproduced in the area of the image portion in substantially the same color at the first color, thereby not reproducing the first image portion.

6. The document of claim 5, wherein at least one of the background portion and the image portion is printed at a line frequency greater than about 175 lines per inch.

7. A document carrying an image comprising:
a background portion having printed lines dots or spots at a first angle and at a first line frequency;
an image portion having printed lines dots or spots at a second angle and at a second line frequency,
wherein the first line frequency is at least two time greater than the second line frequency.

8. The document of claim 7, wherein the first line frequency is greater than about 175 lines per inch.

9. The document of claim 7, wherein an image formed by the image portion is substantially hidden, and when the document is reproduced by a copying or scanning device, the image formed by the image portion is not substantially hidden in the reproduced document.

10. An apparatus for authenticating a document as an original document comprising:
a magnification unit capable of magnifying images contained on the document;
a scanning unit capable of scanning images magnified by the magnification unit, and creating an electronic format of the images contained on the document;
a microprocessor which receives the electronic format and determines if the document contains predetermined security images which are not reproduced when the a reproduction of the document is made by a copying or scanning device,
wherein the microprocessor determines the document not to be an original document if predetermined security images are not detected.

11. The apparatus of claim 10, wherein the microprocessor compares a layout of the document to a layout of the original document, and the microprocessor determines the document to be an original document if the layout of the document corresponds to the layout of an original document.

12. The apparatus of claim 11, further comprising a display which displays a message indicative of whether the document has been determined to be an original document.

13. A method of authenticating a document as an original document comprising the steps of:
reviewing the document for the presence of predetermined security images which are not reproduced when a reproduction of the document is made by a copying or scanning device; and
determining the document not to be an original if the predetermined security images are not present in the document.

14. The method of claim 13, further comprising the steps of comparing a layout of the document to a layout of the original document, and determining the document to be an original document if the layout of the document corresponds to the layout of an original document.

15. The method of claim 14, further comprising the step of displaying a message indicative of whether the document has been determined to be an original document.

16. A computer readable medium carrying instructions to cause a computer to perform a method of authenticating a document as an original document comprising the steps of:
reviewing the document for the presence of predetermined security images which are not reproduced when a reproduction of the document is made by a copying or scanning device; and
determining the document not to be an original if the predetermined security images are not present in the document.

17. The computer readable medium of claim 16, wherein the method further comprises the steps of comparing a layout of the document to a layout of the original document, and determining the document to be an original document if the layout of the document corresponds to the layout of an original document.

18. The computer readable medium of claim 17, wherein the method further comprises the step of displaying a message indicative of whether the document has been determined to be an original document.
